(19) United States
(12) Patent Application Publication
(10) Pub. No.: US 2011/0179665 A1
(43) Pub. Date: Jul. 28, 2011

(54) Or Relating to Rolls

(75) Inventor: Anthony John Ashton, Lancashire (GB)

(73) Assignee: RICHARD HOUGH LIMITED, Bolton (GB)

(21) Appl. No.: 13/058,181

(22) PCT Filed: Aug. 21, 2009
(86) PCT No.: PCT/GB09/02048

§ 371 Date: Feb. 8, 2011

(30) Foreign Application Priority Data
Oct. 13, 2008 (GB) 0818771.8

(51) Int. Cl. F16C 13/00

(52) U.S. Cl. 34/95.3

(57) ABSTRACT

There is disclosed a de-watering squeeze roll which is particularly intended for use in the watering operations in textile industries. The roll comprises a shaft, a relatively thick resilient sub-layer provided around the shaft, and a relatively thin resilient outer cover provided around the sub-layer. The sub-layer has a hardness greater than the hardness of the outer cover such that the sub-layer is formed from material having a Shore A hardness of between 85 and 105 whilst the outer cover is formed from material having a Shore A hardness of between 60 and 80.

### BACKGROUND OF THE INVENTION

The present invention relates to a roll and an apparatus comprising such a roll. The invention relates particularly to a squeeze roll and related apparatus suitable for use in the textile industry.

### DESCRIPTION OF THE PRIOR ART

It is known in the textile industry to use squeeze rolls for mechanical drying of wet textiles. Conventionally, rubber covered squeeze rolls are used for this purpose in textile handling machinery such as squeezers, de-watering machines, mangles, foulards, hydro-extractors and presses. It is also to be appreciated that rolls in accordance with the present invention could be used for de-watering purposes in the paper industry, where suction rolls and press rolls are used.

Conventional rubber covered rolls comprise a central metal shaft having a journal section located at each end. A resilient cover material is provided over the shaft, the resilient material typically having a radial thickness of between 10 mm and 20 mm. Whilst natural rubber can be used for the resilient covering, it is more conventional to use synthetic elastomeric substances such as nitrile.

In a typical de-watering machine such as a mangle, two squeeze rolls are arranged to run against one another, and are urged towards one another so that wet textile material can be passed through the nip defined between the two rollers, the rollers serving to squeeze liquid out of the textile material.

Rubber covered squeeze rolls have been found to be particularly useful in squeezing water from textile materials as the resilient material provided around the central shaft of the roll deforms slightly under the squeezing pressure applied to the roll, thereby increasing the area of the roll in contact with the textile material as it passes through the nip between the two rolls.

Prior art rubber covered squeeze rolls of the type described above typically use resilient material having a hardness of approximately 95 Shore A. Resilient material of this level of hardness has been found to provide a reasonable balance between allowing sufficient defamation in order to increase the surface area of the roll in contact with textile material at the nip, whilst also retaining sufficient rigidity to provide an effecting squeezing action.

However, prior art rubber covered squeeze rolls of the type described above are not without problems and although they have been found to provide reasonable results when used in textile de-watering machines, significant nip-pressure is still required in order to provide acceptable squeezing performance.

### SUMMARY OF THE INVENTION

It is therefore an object of the present invention to provide an improved squeeze roll.

Accordingly, a first aspect of the present invention provides a de-watering roll comprising a shaft, a relatively thick resilient sub-layer provided around the shaft, and a relatively thin resilient outer cover provided around the sub-layer, the sub-layer having a hardness greater than the hardness of the outer cover, wherein the sub-layer is formed from material having a shore A hardness of between 85 and 105.

Preferably, the thickness of the outer cover is approximately equal to 10% of the thickness of the sub-layer.

In a preferred arrangement, the sub-layer has a radial thickness of between 10 mm and 20 mm.

The outer cover preferably has a radial thickness of between 1 mm and 2 mm.

In a preferred embodiment, the sub-layer is formed from material having a Shore A hardness of between 90 and 100, and most preferably from material having a Shore A hardness substantially equal to 95.

Preferably, the outer cover is formed from material having a Shore A hardness of between 60 and 80, more preferably from material having a Shore A hardness of between 65 and 75, and most preferably from material having a Shore A hardness substantially equal to 70.

Advantageously, the combination of the sub-layer and the outer cover has a Shore A hardness of between 80 and 85.

Conveniently, the sub-layer and the outer cover are each formed from an elastomeric material.

Preferably, the sub-layer and the outer cover are each formed from a material selected from the group comprising nitrile rubber, polyurethane rubber, CSPE, EPDM, and HNBR.

Advantageously, the squeeze roll has an overall diameter of between 250 mm and 400 mm.

Conveniently, the outer-cover has a substantially constant thickness over substantially its entire extent.

According to another aspect of the present invention, there is provided an apparatus for squeezing liquid from textiles, the apparatus comprising at least one roll of the type defined above.

Preferably, the apparatus comprises at least one pair of rolls of the type defined above, wherein each said roll is arranged to run against the other said roll.

### BRIEF DESCRIPTION OF THE DRAWINGS

So that the invention may be more readily understood, and so that further features thereof may be appreciated, embodiments of the invention will now be described by way of example with reference to the accompanying drawings in which:

FIG. 1 is a perspective view of a squeeze roll in accordance with the present invention;

FIG. 2 is a transverse cross sectional view taken through the squeeze roll illustrated in FIG. 1.

### DETAILED DESCRIPTION OF THE PREFERRED EMBODIMENTS

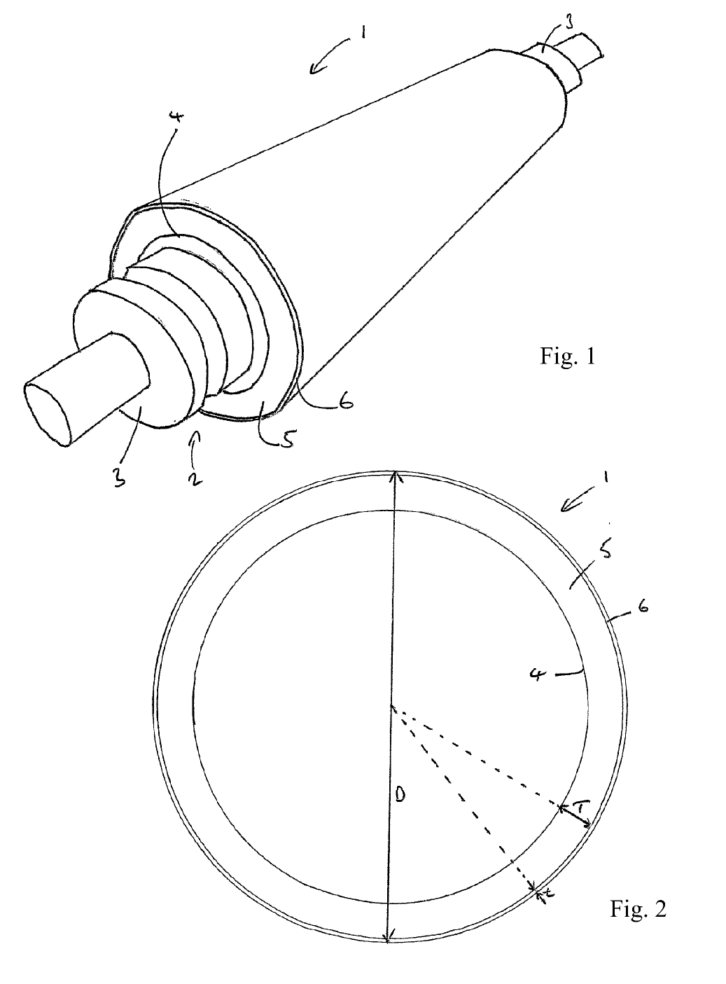

Referring initially to FIG. 1, there is illustrated a squeeze roll 1 in accordance with the present invention. The roll comprises an elongate central shaft 2 which is typically made from solid metal, and most preferably steel. The shaft 2 has a short journal section 3 provided at each end, the journal sections being configured for engagement with, and support by, a cooperating bearing provided in a de-watering machine (not shown). It is to be appreciated that the shaft 2 can be made either from solid metal, tubular metal, or in a form comprising a solid metal core provided within an overhanging metal tube, as is known for use in providing a variable pressure roll or an anti-deflection roll. Alternatively, the shaft can be made from composite materials such as carbon fibre material.

Between the two journal sections 3, the shaft 2 has an elongate central section 4 of substantially uniform circular cross section.

A resilient sub-layer 5 of elastomeric material is provided around the central roll section 4 of the shaft 2, the resilient sub-layer 5 thus having a substantially tubular configuration. The resilient sub-layer 5 can be formed from any convenient elastomeric material, such as those typically used in conventional squeeze roll technology. However, for the purposes of the present invention, it is preferred that the elastomeric material of the sub-layer 5 be selected from the group comprising nitrite rubber, polyurethane rubber, chlorosulfonated polyethylene (CSPE) (commonly known by the trade mark Hypalon), ethylene propylene diene M-class rubber (EPDM), and hydrogenated nitrile butadiene rubber (HNBR).

The resilient sub-layer 5 is configured so as to have a Shore A hardness of between 85 and 105, but more preferably to have a Shore A hardness of between 90 and 100. It has been found that the squeeze roll of the present invention performs most effectively when the sub-layer is formed from material having a Shore A hardness substantially equal to 95.

A thin layer of resilient material is provided over and around the resilient sub-layer 5 in the form of a resilient outer cover 6. As can be seen from FIG. 1, the outer cover 6 is relatively thin in comparison to the relatively thick resilient sub-layer 5 (thickness being measured in the radial sense).

The outer cover 6 may be formed from natural rubber, but is most preferably formed from a synthetic elastomeric material such as nitrite rubber, polyurethane rubber, chlorosulfonated polyethylene (CSPE) (commonly known by the trade mark Hypalon) or etheylene propylene diene M-class rubber (EPDM).

The resilient outer cover 6 is configured so as to have a level of hardness lower than that of the underlying sub-layer 5. Accordingly, preferred embodiments of the present invention are configured such that the material of the resilient outer cover 6 has a Shore A hardness of between 60 and 80. More preferably the material of the outer cover 6 has a Shore A hardness of between 65 and 75, with a Shore A hardness of substantially equal to 70 being most preferable.

The relatively thin outer cover 6, which effectively forms a thin membrane of softer rubber over the underlying sub-layer 5, may be bonded to the sub-layer 5 in calendered sheet form or tape form, or may be open-cast or ribbon-flow cast in one-component or two-component form, or extruded in strip or cross-head form, or formed as a cast compound. The final choice of material used to form the outer cover 6 has been found to depend on various factors such as the running temperature, and the running pressure of the de-watering machinery, and the required level of resistance to processing chemicals and abrasion resistance.

Turning now to consider FIG. 2, D denotes the overall diameter of the squeeze roll 1, T denotes the radial thickness of the resilient sub-layer 5, and t denotes the radial thickness of the resilient outer cover 6. It is envisaged that most practical embodiments of the squeeze roll of the present invention will have an overall diameter D of between 250 mm and 400 mm. The thickness T of the resilient sub-layer 5 is between 10 mm and 20 mm, with the relatively thin resilient outer cover 6 having a thickness t of less than or equal to 2 mm. Most preferably, the outer cover 6 has a thickness t of between 1 mm and 2 mm. As will therefore be appreciated, preferred embodiments of the squeeze roll have an outer cover 6 which is approximately equal in thickness to 10% of the thickness of the under lying sub-layer 5.

A squeeze roll in accordance with the preferred embodiment of the present invention, where the relative thicknesses of the sub-layer 5 and the outer cover 6 are provided in the ratio described above, with the sub-layer 5 having a Shore A hardness substantially equal to 95 and the outer cover 6 having a Shore A hardness substantially equal to 70, has been found to have an effective Shore A hardness of the combination of the two layers falling in the range of 80 to 85.

The above-described squeeze roll 1 of the present invention has been found to provide significantly improved de-watering performance when used to squeeze liquid from wet textiles. This increased performance arises because the softer outer cover 6 is sufficiently resilient to conform closely to the textured surface of the fabric, thereby squeezing liquid out of cavities between the warp and weft yarns of the fabric or between the surface contours of the fabric. Also, the relatively thin and softer outer cover 6 provides a top layer which is more deformable than prior art rubber covered squeeze rolls and thus increases the efficiency of the squeezing nip between two such rollers by effectively increasing the area of contact between the two rollers and the fabric with minimum loss of nip force. The relatively softer outer cover 6 also gives the added advantage of squeezing the textile fabric more gently than would be the case with prior art rubber coated squeeze rolls having a significantly harder outer surface.

However, the relatively hard and thick underlying sub-layer 5 plays an important role in the improved performance of the squeeze roll 1 of the present invention because it retains sufficient resilience to provide sufficient squeezing force. Effectively, therefore, the softer outer cover 6 is provided to gently and closely conform to the textile fabric passing the roll, whilst the underlying relatively hard sub-layer 5 supports the thin outer cover 6 to provide sufficient squeezing force.

The performance of de-watering squeeze rolls and associated machinery is generally expressed as a percentage weight of the dry fabric. For example, if a sample of dry fabric weighs 1000 g, and after squeezing the weight of wet fabric is found to be 1500 g, the level of expression achieved is said to be 1500/1000 g=50%.

Squeeze rolls in accordance to the present invention have been found to provide increased squeezing performance of between 10 to 15% depending upon the type of fabric processed. Squeeze rolls in accordance with the present invention provide particularly good squeeze performance when used on knitted fabrics which have many small cavities, with the increased squeezing effect on such fabrics typically being as much as 20 to 80%.

It is important that the outer cover 6 is not made too thick in relation to the underlying sub-layer 5. It has been found through experiment that the performance characteristics of a roll in accordance with the present invention begin to deteriorate significantly when the thickness of the outer cover 6 is increased beyond 2 mm.

It is known to provide squeeze rolls with a parabolically cambered profile in order to ensure substantially uniform nip pressure as the rolls bend when placed under load in the de-watering machine. It is therefore envisaged that rolls in accordance with the present invention could be configured so as to have such a profile, in which case the relatively thick sub-layer 5 could be ground so as to have the desired parabolic camber prior to the relatively thin outer cover 6 being applied over the sub-layer 5. The outer cover 6 can then be applied and the cover re-ground to adopt the same parabolic profile, thus maintaining uniform thickness over the entire extent of the outer cover 6.

A roll in accordance with the present invention can be used in conjunction with a conventional steel roll or a conventional rubber covered squeeze roll in order to define a nip between the two rolls, although optimum performance will be obtained by running two squeeze rolls in accordance with the present invention in combination with one another.

In the event that the roll of the present invention is to be used for de-watering purposes in the manufacture of paper, then it is envisaged that the two-layer resilient covering would be provided with an array of holes or grooves for connection to otherwise conventional vacuum extraction equipment.

When using the specification and claims, the terms “comprises” and “comprising” and variations thereof mean that the specified features, steps or integers are included. The terms are not to be interpreted to exclude the presence of other features, steps or components.

The features disclosed in the forgoing description, or the following claims, or the accompanying drawings, expressed in their specific forms or in terms of a means for performing the disclosed function, or a method or process for obtaining the disclosed results, as appropriate may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A de-watering roll comprising a shaft, a relatively thick resilient sub-layer provided around the shaft, and a relatively thin resilient outer cover provided around the sub-layer, the sub-layer having a hardness greater than the hardness of the outer cover, wherein the sub-layer is formed from material having a Shore A hardness of between 85 and 105.

2. A roll according to claim 1, wherein the thickness of the outer cover is approximately equal to 10% of the thickness of the sub-layer.

3. A roll according to claim 1, wherein the sub-layer has a radial thickness of between 10 mm and 20 mm.

4. A roll according to claim 1, wherein the outer cover has a radial thickness of between 1 mm and 2 mm.

5. A roll according to claim 1, wherein the sub-layer is formed from material having a Shore A hardness of between 90 and 100.

6. A roll according to claim 5, wherein the sub-layer is formed from material having a Shore A hardness substantially equal to 95.

7. A roll according to claim 1, wherein the outer cover is formed from material having a Shore A hardness of between 60 and 80.

8. A roll according to claim 7, wherein the outer cover is formed from material having a Shore A hardness of between 65 and 75.

9. A roll according to claim 8, wherein the outer cover is formed from material having a Shore A hardness substantially equal to 70.

10. A roll according to claim 1, wherein the combination of the sub-layer and the outer cover has a Shore A hardness of between 80 and 85.

11. A roll according to claim 1, wherein the sub-layer and the outer cover are each formed from an elastomeric material.

12. A roll according to claim 1, wherein the sub-layer and the outer cover are each formed from a material selected from the group comprising nitrile rubber, polyurethane rubber, CSPE, EPDM, and HNBR.

13. A roll according to claim 1 having an overall diameter of between 250 mm and 400 mm.

14. A roll according to claim 1, wherein the outer-cover has a substantially constant thickness over substantially its entire extent.

15. An apparatus for squeezing liquid from textiles, the apparatus comprising at least one roll according to claim 1.

16. An apparatus according to claim 15 comprising at least one pair of rolls according to claim 1, wherein each said roll is arranged to run against the other said roll.

17. A de-watering roll substantially as hereinbefore described with reference to and as shown in the accompanying drawings.
